(19) United States
(12) Patent Application Publication
(10) Pub. No.: US 2025/0069329 A1
(43) Pub. Date: Feb. 27, 2025

(54) INFORMATION PROCESSING DEVICE AND STORAGE MEDIUM STORING COMPUTER PROGRAM

(71) Applicant: BANDAI CO., LTD., Tokyo (JP)

(72) Inventor: Ryota KIYOMIYA, Tokyo (JP)

(73) Assignee: BANDAI CO., LTD., Tokyo (JP)

(21) Appl. No.: 18/813,067

(22) Filed: Aug. 23, 2024

(30) Foreign Application Priority Data
Aug. 25, 2023 (JP) 2023-137375

(51) Int. Cl. G06T 17/00

(52) U.S. Cl. CPC G06T 17/00

(57) ABSTRACT

An information processing device including: a scan controller configured to cause a scanner to scan an outer appearance of an object disposed on a table and generate a scan image; a data generator configured to generate 3-dimensional model data from the scan image; a video generator configured to generate a video in which a 3-dimensional model based on the 3-dimensional model data is disposed in a virtual space; and a receiver configured to receive an input of attribute information regarding the object that is a scanning target, in which the video generator is configured to generate the video so that an effect is included for each object in accordance with the attribute information.

### CROSS-REFERENCE TO RELATED APPLICATION

This application is based upon and claims the benefit of priority from Japanese Patent Application No. 2023-137375, filed on Aug. 25, 2023, the entire contents of which are incorporated herein by reference.

### TECHNICAL FIELD

The present invention relates to an information processing device and a computer program.

### BACKGROUND ART

JP2020-107251A discloses a technique for generating a virtual space image viewed from a virtual camera in a virtual space by primitively mapping, in the virtual space, textures that are generated from a captured image group obtained by causing imaging units to image a target in a plurality of imaging directions.

In the generation of the virtual space image as in the above technique, generated 3-dimensional model data is associated with attribute information of an imaging target and generation of a video in accordance with the attribute information is expected when a target is imaged to generate a video in which a 3-dimensional model is disposed in the virtual space using the 3-dimensional model data of the imaged target.

Accordingly, an object of the present invention is to associate generated 3-dimensional model data with attribute information of an imaging target and generate a video in accordance with the attribute information when a target is imaged to generate a video in which a 3-dimensional model is disposed in a virtual space using the 3-dimensional model data of the imaged target.

### SUMMARY OF INVENTION

According to an aspect of the present invention, there is provided an information processing device including:
a scan controller configured to cause a scanner to scan an outer appearance of an object disposed on a table and generate a scan image;
a data generator configured to generate 3-dimensional model data from the scan image;
a video generator configured to generate a video in which a 3-dimensional model based on the 3-dimensional model data is disposed in a virtual space; and
a receiver configured to receive an input of attribute information regarding the object that is a scanning target,
in which the video generator is configured to generate the video so that an effect is included for each object in accordance with the attribute information.

### BRIEF DESCRIPTION OF DRAWINGS

FIG. 1 is a diagram illustrating an example of a configuration of an image processing system according to an embodiment.

FIGS. 2A and 2B are diagrams illustrating an example of a hardware configuration of an information processing device and an example of a hardware configuration of a headset according to the embodiment.

FIG. 3 is a diagram illustrating an example of an outer appearance of a humanoid model according to the embodiment.

FIG. 4A is a diagram illustrating an example of implementation of the image processing system.

FIG. 4B is a diagram illustrating an example of a configuration during scanning and imaging of the image processing system according to the embodiment.

FIGS. 5A to 5F are diagrams illustrating a relation between a scanner device and a rotational position of a turntable during the scanning and imaging according to the embodiment.

FIG. 6 is a flowchart illustrating an example of a process in the image processing system according to the embodiment.

FIG. 7 is a diagram illustrating an example of an attribute designation screen according to the embodiment.

### DESCRIPTION OF EMBODIMENTS

Hereinafter, an embodiment will be described in detail with reference to the appended drawings. The following embodiment does not limit the present invention according to the claims and all combinations of features described in the embodiment are not requisite for the present invention. Of a plurality of features described in the embodiment, two or more features may be arbitrarily combined. The same reference numerals denote the same or similar configurations and repeated description thereof will be omitted. In each drawing, upper, lower, left, right, front, and back directions relative to the sheet are used as upper, lower, left, right, front, and back directions of components (parts) in the embodiment in description of the text.

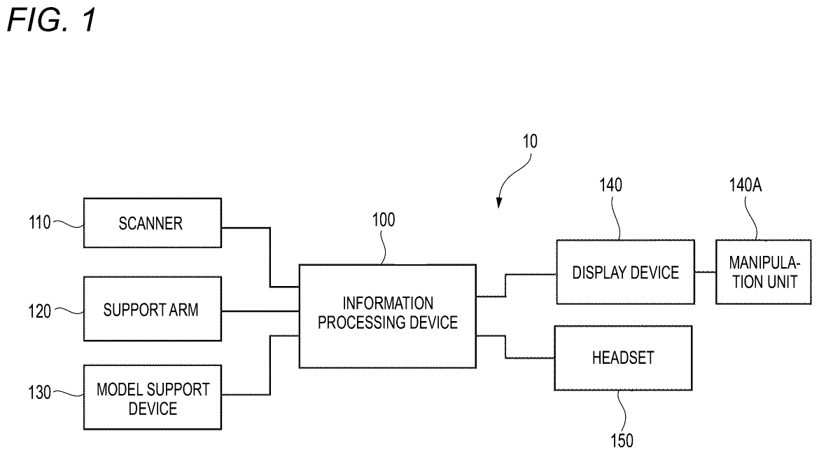

First, a configuration of an image processing system according to an embodiment will be described. FIG. 1 is a diagram illustrating an example of a configuration of an image processing system 10 according to the embodiment. In the image processing system 10, a scanner 110, a support arm 120, a model support device 130, a display device 140, a headset 150, and the like are connected to an information processing device 100. The configuration of the system is not limited to the configuration illustrated in FIG. 1, and the information processing device 100 may be further connected to an external server, a cloud server, or the like via a network. In the external server or the like, at least some of processes according to the embodiment to be described below can be performed.

The information processing device 100 controls an operation of at least any one of the scanner 110, the support arm 120, and the model support device 130, images an imaging target item at any angle to generate a plurality of images, and generates 3-dimensional model data (present data) from the plurality of images. When the imaging target item can be separated into a plurality of constituent items, 3-dimensional model data may be generated by imaging each constituent item and 3-dimensional model data of the target item may be generated by integrating the 3-dimensional model data.

The information processing device 100 can also function as a video generation device that generates a video that is displayed in a virtual space by using the generated 3-dimensional model data as virtual space data. In the embodiment, an imaging target object is any of items such as an assembly plastic model, an action figure (a figure that has movable joints), a toy, and a doll, which are collectively referred to as “models” below.

Next, the scanner 110 is a 3-dimensional scanner device that images (scans) a 3-dimensional shape of an imaging target model under the control of the information processing device 100 and outputs the 3-dimensional shape and color information of the imaging target. In the embodiment, scan signals output from the scanner 110 are collectively referred to as a “scan image”. As the scanner 110, for example, Space Spider manufactured by Artec Co., Ltd. can be used. In the embodiment, for example, by acquiring about 500 frames to 800 frames of the scan images, it is possible to acquire 3D scan data of an entire toy. As the scanner 110, for example, a smartphone with a camera in which an application for capturing a 3-dimensional shape is installed may be used.

The support arm 120 is a position and pose control device that moves the scanner 110 to a predetermined imaging position and pose under the control of the information processing device 100. The support arm 120 may be configured to change an imaging position and pose manually and to maintain the changed position and pose fixedly or may be configured to be able to be controlled by the information processing device 100. When the support arm 120 can be controlled by the information processing device 100, for example, xArm7 manufactured by UFACTORY Co. Ltd., can be used. xARM7 includes seven joints and can move similarly to a human arm. Instead of the support arm 120, the scanner 110 can be positioned manually. For an imaging position and pose that cannot be covered by the support arm 120, the scanner 110 may be manually operated to perform scanning.

The model support device 130 is a support stand that supports a model fixed at a pose (or an installation table on which a model is installed). The model support device 130 may be configured to be able to rotate when the model is installed on the support stand or at the distal end of a support rod. In the embodiment, after the scanner 110 is positioned at any imaging position and imaging angle by the support arm 120, the model support device 130 is rotated to perform imaging. The model support device 130 can rotate in both clockwise and counterclockwise directions. The model support device 130 can be stopped at any rotational angle within a range of 0 to 360 degrees, and imaging can also be performed by stopping the model support device 130 at a specific rotational angle and positioning the model support device 130 at any imaging position and imaging angle within a movable range of the scanner 110. By performing the operation described above at a plurality of rotational angles, imaging positions, and imaging angles, it is possible to obtain an image of an entire model. Here, by synchronously driving the model support device 130 and the support arm 120, it is possible to perform an imaging process more simply and with high accuracy. Instead of the model support device 130, the scanner 110 may be moved manually around the model to perform scanning at any imaging position and imaging angle.

The display device 140 is a display device such as a liquid crystal display (LCD) and can display a processing result in the information processing device 100. Specifically, images acquired with the scanner 110 can be displayed, the present data of the 3-dimensional model data generated from the captured images can be displayed or a video restored using the present data (VR video) can be displayed. The display device 140 can include a manipulation unit 140A that receives a manipulation from a user who is an observer of a display video, and thus the user can manipulate the manipulation unit 140A to perform a manipulation input in accordance with content of a video displayed on the display device 140.

The headset 150 includes a head-mounted display 150A and a controller 150B to be described below. In particular, the VR headset may be configured to provide a moving image corresponding to a pose or an inclination of the user who is an observer. A predetermined application can be installed in the headset 150, and application data that is executed in the application can be downloaded from the information processing device 100 to be executed. In the embodiment, like the information processing device 100, the headset 150 can also function as a video generation device that generates a video displayed on a virtual space using the 3-dimensional model data as virtual space data and provides the generated video as a VR video. The application data includes display data for displaying the VR video.

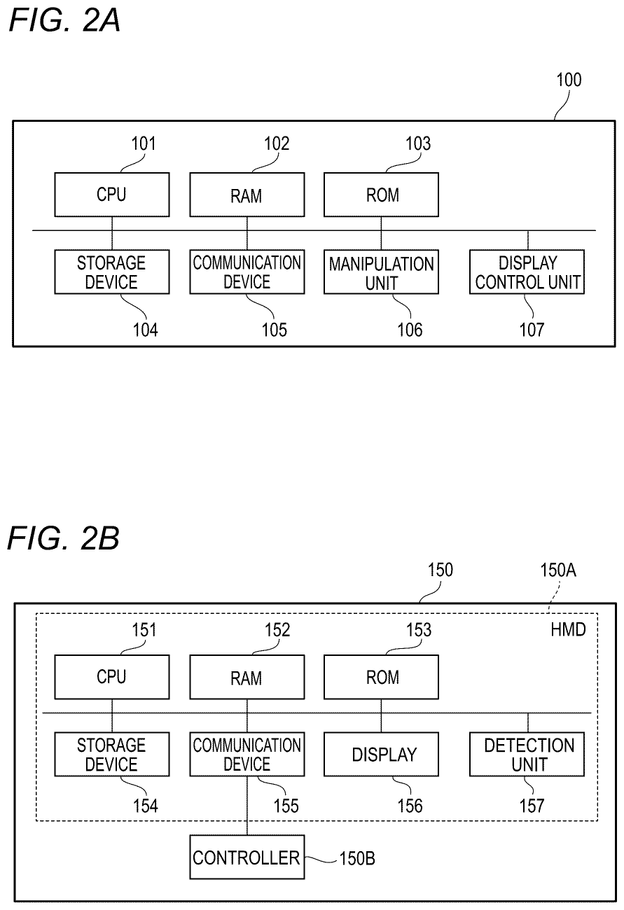

Next, a hardware configuration of the information processing device 100 according to the embodiment will be described. FIG. 2A illustrates an example of a hardware configuration of the information processing device 100. A CPU 101 is a device that controls the entire information processing device 100 and computes, processes, and manages data. For example, timings at which images are captured and the number of captured images in the scanner 110 can be controlled and arm joints of the support arm 120 can be controlled to dispose the scanner 110 at any imaging position and imaging angle. For example, after the imaging position and the imaging angle of the scanner 110 are determined, the model support device 130 can be rotated and an imaging operation can be performed by the scanner 110. After the model support device 130 is stopped at a predetermined rotational angle, an imaging operation can be performed at any imaging position and imaging angle by the scanner 110.

The CPU 101 can also function as an image processing unit that processes an image output from the scanner 110. Specifically, the CPU 101 can perform a process of generating a video in which a 3-dimensional model is displayed in a virtual space using the 3-dimensional model data generated based on a scan signal obtained by the scanner 110 as virtual space data.

A RAM 102 is a volatile memory and is used as a main memory of the CPU 101 or a temporary storage area such as a work area. A ROM 130 is a nonvolatile memory and stores image data or other data, various programs causing the CPU 101 to operate, and the like in predetermined areas. The CPU 101 controls each unit of the information processing device 100 using the RAM 120 as a work memory in accordance with the program stored in, for example, the ROM 103. The program causing the CPU 101 to operate may be stored not in the ROM 103 but in the storage device 104.

The storage device 104 is configured with, for example, a magnetic disk such as a flash memory or an HDD. The storage device 104 stores an application program, an OS, a control program, an associated program, a game program, and the like. The storage device 104 can read and write data under the control of the CPU 101. The storage device 104 may be used instead of the RAM 102 or the ROM 103.

A communication device 105 is a communication interface that communicates with the scanner 110, the support arm 120, the model support device 130, the display device 140, and the headset 150 under the control of the CPU 101. The communication device 105 may be further configured to be able to communicate with an external server or the like. The communication device 105 can include a wireless communication module. The module can include a known circuit mechanism that includes an antenna system, an RF transceiver, one or more amplifiers, a tuner, one or more oscillators, a digital signal processor, a CODEC chip set, a subscriber identification module card, and a memory. Here, communication performed by the information processing device 100 with the scanner 110, the support arm 120, the model support device 130, the display device 140, and the headset 150 may be wireless communication.

The communication device 105 can also include a wired communication module for wired connection. The wired communication module enables communication with another device including the display device 140 via one or more external ports. The wired communication module can include various software components that process data. The external ports are coupled with other devices directly or indirectly via a network via an Ethernet, a USB, an IEEE1394, and the like. The wired communication module can also be configured as an alternative of a hardware device by software that implements the same function as each of the above devices.

A manipulation unit 106 is configured with, for example, a button, a keyboard, a touch panel, a controller, or the like and receives a manipulation input from a user. The manipulation unit 106 may be common to the manipulation unit 140A or may be independent of the manipulation unit 140A. For example, when the manipulation unit 140A is assumed to be a manipulation unit configured as a keyboard and a mouse, and the like, the manipulation unit 140A can be common to the manipulation unit 106. On the other hand, when the manipulation unit 140A is assumed to be a manipulation unit configured as a touch panel, a controller, or the like, the manipulation unit 140A can be a manipulation unit independent of the manipulation unit 106.

A display control unit 107 functions as a control unit that displays information on the display device 140 connected to the information processing device 100 and controls an operation of the display device 140. Some functions of the manipulation unit 106 may be included in the display device 140. For example, the display device 140 may be configured as a device that includes a touch panel like a tablet terminal.

Next, a hardware configuration of the headset 150 according to the embodiment will be described. FIG. 2B illustrates an example of a hardware configuration of the headset 150. The headset 150 includes a head-mounted display (HMD) 150A and a controller 150B. The HMD 150A enables a user to feel a virtual reality (VR) experience by providing right-eye and left-eye videos to the right and left eyes of the user, respectively, and allowing a stereoscopic effect by a parallax. The controller 150B is provided in a casing independent of the HMD 150A. The controller 150B is configured as a pair of two controllers held and manipulated by right and left hands of the user, but may be configured as a single controller.

A CPU 151 is a device that controls the entire headset 150 and computes, processes, and manages data. For example, application data downloaded from the information processing device 100 can be executed and a VR video can be displayed on a display 156. Based on a manipulation received via a controller 156 or information detected by a detection unit 158, the displayed VR video can be switched, a viewpoint in a VR space can be switched, or a position in the VR space can be changed.

A RAM 152 is a volatile memory and is used as a main memory of the CPU 151 or a temporary storage area such as a work area. A ROM 153 is a nonvolatile memory and stores image data or other data, various programs causing the CPU 151 to operate, and the like in predetermined areas. The CPU 151 controls each unit of the headset 150 using the RAM 152 as a work memory in accordance with the program stored in, for example, the ROM 153. The program causing the CPU 151 to operate may be stored not in the ROM 153 but in the storage device 154.

The storage device 154 is configured with, for example, a magnetic disk such as a flash memory or an HDD. The storage device 154 stores an application program, an OS, a control program, an associated program, a game program, application data or display data downloaded from the information processing device 100, and the like. The storage device 154 can read and write data under the control of the CPU 151. The storage device 154 may be used instead of the RAM 152 or the ROM 153.

A communication device 155 is a communication interface that communicates with the information processing device 100 or the controller 150B under the control of the CPU 151. The communication device 155 includes a wireless communication module that enables wireless communication that is based on Bluetooth or WiFi (IEEE802.11). The headset 150 is connected to the information processing device 100 through wireless communication so that the display data of the VR video can be downloaded. Communication with the controller 150B is performed to receive information regarding a manipulation instruction of the user on the controller 150B.

A display 156 is configured such that right-eye and left-eye videos generated by the CPU 151 are provided to the right and left eyes of the user, respectively. A detection unit 157 is a mechanism that detects visual line directions of the right and left eyes of the user and detect an inclination of the head-mounted display. The detection unit 157 includes, for example, a sensor that detects a visual line direction or a gaze direction of the user wearing the HMD 150A. The detection unit 157 includes a gyroscope, magnetometer, an accelerometer, a global positioning system (GPS), and a compass and can specify a position, a pose, an inclination, and the like of the HMD 150A in accordance with such detection information. The detection unit 157 detects information for determining a gaze direction or an action of the user in the HMD 150A and transmits the information to the CPU 151. The CPU 151 determines the gaze direction or the action based don the received detection information and adjusts a video presented on the display 156 of the HMD 150A so that the video matches the determined gaze direction or action.

The controller 150B includes, for example, a plurality of buttons and a cross key and receives a manipulation input such as a selection manipulation or a direction instructing manipulation from the user. The controller 150B is connected to the HMD 150A via the communication device 155 through wireless communication.

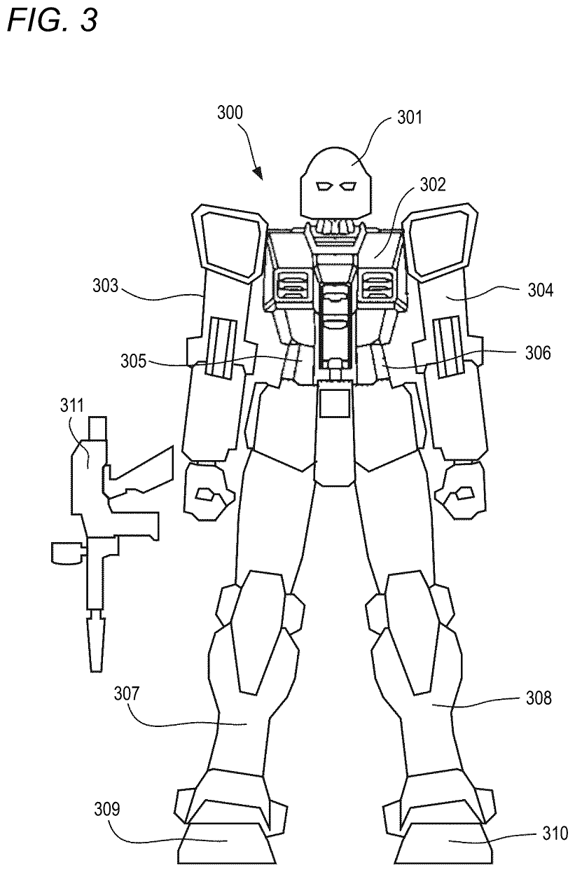

Next, an example of a model and an attachment thereof that are imaging target objects according to the embodiment will be described with reference to FIG. 3. A model 300 is a model that has a humanoid outer appearance (a robot or a person). The model can be assembled and painted as, for example, a plastic model. Alternatively, the model may be a completed model such as a figure that has movable joints (action figure). The model of FIG. 3 is merely exemplary for description, and the shape of the model is not limited to the humanoid outer appearance and may be any shape of a model such as a general vehicle, a race vehicle, a military vehicle, an aircraft, a ship, an animal, a virtual creature. An imaging target item is, of course, not limited to a model as long as a 3-dimensional shape of the item can be imaged by the scanner 110.

The model 300 includes components such as a head part 301, a chest part 302, a right arm part 303, a left arm part 304, a right torso part 305, a left torso part 306, a right leg part 307, a left leg part 308, a right foot part 309, a left foot part 310, which are assembled together. At least some of the parts 301 to 310 are supported to be rotatable (or swingable) relative to adjacent parts. For example, the head part 301 is supported to be rotatable relative to the chest part 302, and the right arm part 303 and the left arm part 304 are supported to be rotatable relative to the chest part 302. Since the parts of the model 300 have such a joint structure, the model 300 can take any pose.

An attachment 311 is incidental to the model 300. The attachment 311 is an attachment component that is assumed to be used together with the model 300 and is a weapon that has a rifle shape in FIG. 3. That is, it is assumed that the model 300 holds the attachment 311 with both hands to use the attachment 311. The shape of the weapon is not limited to the rifle shape and a weapon with any shape such as a sword shape, a shield shape, a bomb shape (for example, a grenade), or a Bazooka shape can be included. The attachment is not limited to a weapon as long as the attachment is an attachment component that can be used together with the model 300, and may be a decoration. For example, when the model 300 is a humanoid model of a specific character, the attachment may be any of various items carried by the character (for example, a portable article, a hat, a bag, an accessory, a smartphone, or any item that can be carried by the character).

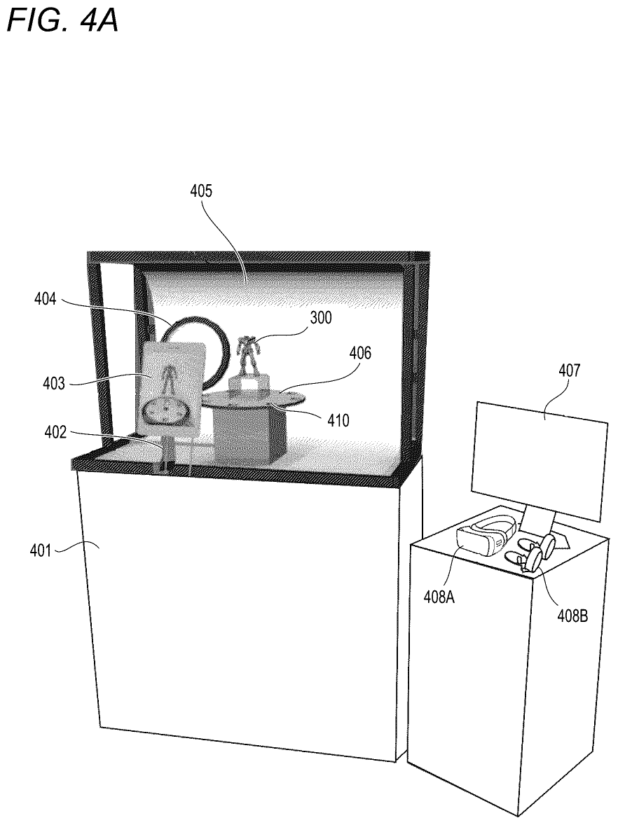

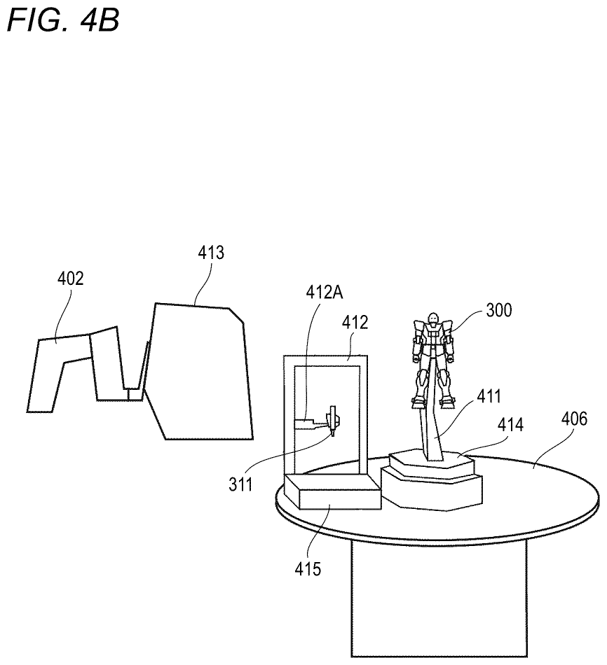

Next, an overall implementation example of the image processing system 10 according to the embodiment will be described with reference to FIG. 4A. FIG. 4A is a diagram illustrating a general implementation example in which the present data generated by imaging the model can be generated.

In FIG. 4A, a driving system that drives the information processing device 100 and the support arm 402 and a driving system that drives a turntable 406 are included in a case 401. An imaging direction and position of the support arm 402 can be adjusted manually. The surface of the case 401 has a flat structure to which an advertising poster can be attached.

The support arm 402 corresponds to the support arm 120 and can support a terminal 403 functioning as the scanner 110 manually or under the control of the information processing device 100 to fix the position of the terminal 403. The support arm 402 can also operate to control an inclination of the terminal 403.

The terminal 403 is a touch panel type terminal that can be used as the scanner 110 and contains a camera. For example, a smartphone, a tablet terminal, a digital camera, or the like can be used. Instead of such a terminal, Space Spider manufactured by Artec Co., Ltd. can also be used. FIG. 4A is just a diagram illustrating a generalized example of a system configuration. The configuration can be realized in accordance with a type of device used as the scanner 110. The terminal 403 can capture an image of the model 300 and can transmit the image to the information processing device 100. A ring light 404 is an illumination device used when the model 300 is imaged by the terminal 403, and evenly light the model 300 so that the shadow is minimized. As an additional light source, a top light or supplementary lights on the right, left, and lower sides may be installed in addition to the ring light 404. Instead of the terminal 403, the above-described 3-dimensional scanner device may also be used.

A background sheet 405 is an imaging background sheet. For example, a white sheet can be used. The model 300 is mounted on the turntable 406 that can be rotated with the model thereon. A configuration that includes the turntable 406 and the driving system corresponds to the model support device 130 and clockwise and counterclockwise rotating and stopping operations of the turntable 406 is performed under the control of the information processing device 100. A plurality of predetermined markers 410 may be disposed on the turntable 406. The markers 410 can be used to adjust a direction or a position of an imaged model.

In FIG. 4A, the model is disposed on a semi-transparent (transparent) table. Additionally, for example, a support mechanism called “Action Base” (registered trademark) may be used. In Action Base, a support pillar configured to be bent into an “L” shape is installed on a pedestal and a model can be mounted at the distal end of the support pillar. The above-described markers 410 may be disposed in the pedestal or at the distal end of the support pillar. An instruction method for the model can be changed in accordance with a pose. For example, in the case of an upright pose, the model can be disposed on the transparent table so that imaging can be performed. On the other hand, when the underside of feet is required to be imaged like a flying pose, Action Base may be used. Action Base may also be used to image an upright pose.

A display device 407 is a device corresponding to the display device 140 and may have a touch panel function. The user can perform a predetermined selection operation using the touch panel function. Instead of the touch panel, a manipulation can also be received by a controller or a mouse (not illustrated) that can function as the manipulation unit 140A. A VR headset 408 includes an HMD 408A and a controller 408B respectively corresponding to the HMD 150A and the controller 150B. The user can wear the HMD 408A on his or her head and hold and manipulate the controller 408B with right and left hands to perform a manipulation while viewing VR videos.

Next, a more specific configuration of the image processing system 10 when the model 300 and the attachment 311 according to the embodiment are simultaneously scanned will be described with reference to FIG. 4B. In FIG. 4B, the model 300 and the attachment 311 are installed on the turntable 406. The model 300 is supported by Action Base 411 and is disposed at a substantially center of the turntable 406. The attachment 311 is supported by a support member 412A inside a frame 412, and is disposed to be adjacent to the model 300 and at an end of the turntable 406. The support member 412A can be, for example, a clip-shaped member. Accordingly, the attachment 411 can be supported inside the frame 412 between clips.

A scanner device 413 is supported by the support arm 402. Here, Space Spider manufactured by Artec Co., Ltd. is assumed to be used. Since a driving system that drives the support arm 402, a driving system that drives the turntable 406, and the like are similar to the systems described in FIG. 4A, description thereof will be omitted. In the embodiment, the turntable 406 can rotate in both clockwise and counterclockwise directions.

In the embodiment, the model 300 and the attachment 311 are collectively installed on the turntable 406 in the form illustrated in FIG. 4B, and imaging is collectively performed by the scanner device 413 to generate a scan image. The scan image includes both the model 300 and the attachment 311. The 3-dimensional model data is generated so that the model 300 and the attachment 311 are separated.

The frame 412 supporting the attachment 311 is configured as a frame surrounding the attachment 311 and is used as an index for identifying a range in which the attachment 311 is disposed. That is, a stereoscopic object located inside the frame 412 is recognized as the attachment 311. A thickness of the frame 412 is preferably as thin as possible in a range in which a strength is maintained so that a visual line of the scanner device 413 is not blocked as much as possible. For example, the thickness can be set to be about 3 mm.

The model 300 and the frame 412 are disposed to be spaced so that a given distance is ensured. The frame 412 may be positioned in front of the model 300 relative to the scanner device 413 and imaging of the model 300 may be shielded depending on a rotational angle of the turntable 406. A portion shielded in this way is necessarily complemented at other rotational angles. When the model 300 and the frame 412 are too close, accuracy of the complement deteriorates. Therefore, the given distance is ensured and the accuracy of the complement is ensured.

At this time, for example, the sizes of the model 300 and the attachment 311 may be limited to sizes equal to or less than predetermined sizes so that the given distance can be ensured (or is not too close) between the model 300 and the frame 412. For example, the size of the model 300 can be set to a length of 15 cm, a width of 15 cm, and a depth of 10 cm or less, and the size of the attachment 311 can be set to a length of 15 cm, a width of 5 cm, and a thickness of 2 cm or less.

In the embodiment, an installation table 414 on which Action Base 411 supporting the model 300 is installed and an installation table 415 on which the frame 412 supporting the attachment 311 is installed are configured so that the installation table 414 is thicker. That is, the model 300 is installed to be located relatively above the attachment 311. For example, at least the upper half body or the upper half of the model 300 can be installed to be located above the frame 412. Accordingly, when the model 300 is scanned, a ratio of being shielded by the attachment 311 can be reduced, and thus a scanning success rate can be improved.

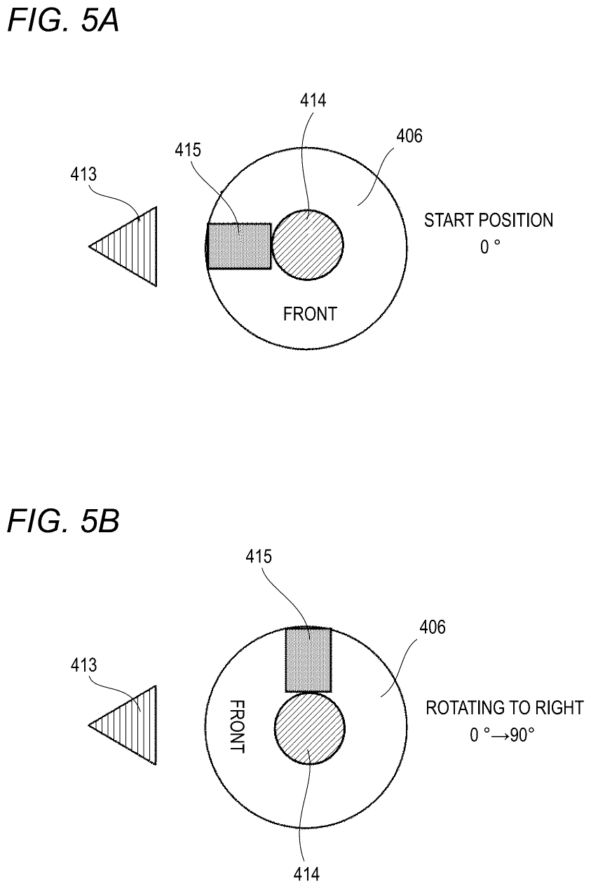

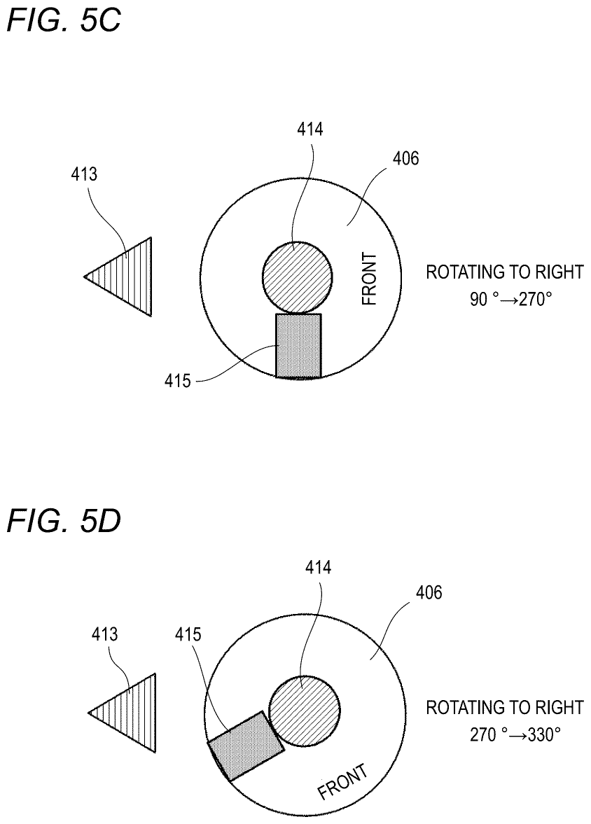

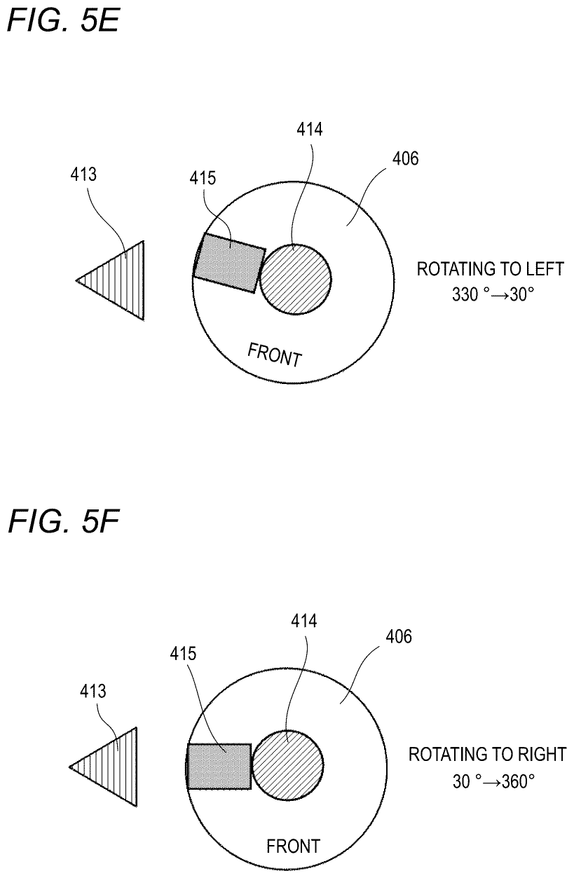

Next, a cooperation operation between the turntable 406 and the support arm 120 during the scanning according to the embodiment will be described with reference to FIGS. 5A to 5F. FIGS. 5A to 5F are diagrams illustrating a relation between a rotational direction and a rotational amount of the turntable 406 relative to the scanner device 413 and the installation tables 414 and 415. In FIGS. 5A to 5F, the model 300 installed on the installation table 414 is disposed so that a direction described as a front is oriented to the front face. The attachment 311 disposed on the installation table 415 can be set similarly.

FIG. 5A illustrates a relation between the scanner device 413 and the installation tables 414 and 415 at a start position of a scanning operation. A rotational angle of the turntable 406 at this time is assumed to be 0 degrees as a reference. When the turntable 406 is rotated in a right direction (clockwise) by 90 degrees from this state, the turntable 406 enters a state illustrated in FIG. 5B. During transition from FIG. 5A to FIG. 5B, the scanner device 413 is located to the lateral side of the turntable 406 to scan the model 300 and the attachment 311. Then, in the state illustrated in FIG. 5B, the support arm 402 is operated to a movable range limit with the front faces of the model 300 and the attachment 311 facing the front of the scanner device 413 to scan the front faces, right and left lateral faces, top faces, and bottom faces of the model 300 and the attachment 311.

Subsequently, from the state of FIG. 5B, the turntable 406 is rotated to the right from a position of 90 degrees to a position of 270 degrees. Meanwhile, the model 300 and the attachment 311 are scanned. Then, in the state illustrated in FIG. 5C, the support arm 402 is operated to the movable range limit with the back faces of the model 300 and the attachment 311 facing the front of the scanner device 413 to scan the back faces, right and left lateral faces, top faces, and bottom faces of the model 300 and the attachment 311.

Subsequently, from the state of FIG. 5C, the turntable 406 is further rotated to the right from the position of 270 degrees to a position of 330 degrees. Meanwhile, the model 300 and the attachment 311 are also scanned. Then, in the state illustrated in FIG. 5D, the support arm 402 is operated to the movable range limit diagonally to the right from the back of the model 300 and the attachment 311 to scan the model 300 and the attachment 311. Through the scanning, the model 300 and the attachment 311 can be scanned so that a portion of the outer appearance of the model 300 shielded by the frame 412 and the attachment 311 (a surface of a side on which the frame 412 or the attachment 311 is disposed among surfaces of the model 300). Here, the case of the scanning performed diagonally to the right from the back has been described, but the scanning may be performed diagonally to the right from the front.

Subsequently, from the state of FIG. 5D, the turntable 406 is rotated from the position of 330 degrees to a position of 30 degrees to the left (counterclockwise). Meanwhile, the scanner device 413 is disposed to view overhead from the upper diagonal side of the model 300 and the attachment 311 and perform scanning. Then, the turntable 406 enters the state illustrated in FIG. 5E. From the state of FIG. 5E, the turntable 406 is rotated to the right (clockwise) from the position of 30 degrees to a position of 360 degrees. Meanwhile, the scanner device 413 is disposed to view upward diagonally from the lower side of the model 300 and the attachment 311 and perform scanning. The turntable 406 enters a state illustrated in FIG. 5F.

The scanner device 413 assumed to be used in the embodiment performs scanning at a substantially middle position (for example, a distance between the scanner device 413 and the model 300 is about 130 mm) in a range in which the scanner device 413 can perform scanning (for example, a distance from 90 mm to 180 mm). In this case, when the attachment 311 passes between the scanner device 413 and the model 300, there is a concern of a defect occurring in that the model 300 is shielded by the attachment 311 and the scanning target is lost. As described above, by rotating the turntable 406 to the right, also rotating the turntable 406 reversely to the left, and performing the scanning, and performing the scanning so that a shielding range is complemented, it is possible to reliably acquire the 3-dimensional model data of each of the model 300 and the attachment 311 without losing the scanning target.

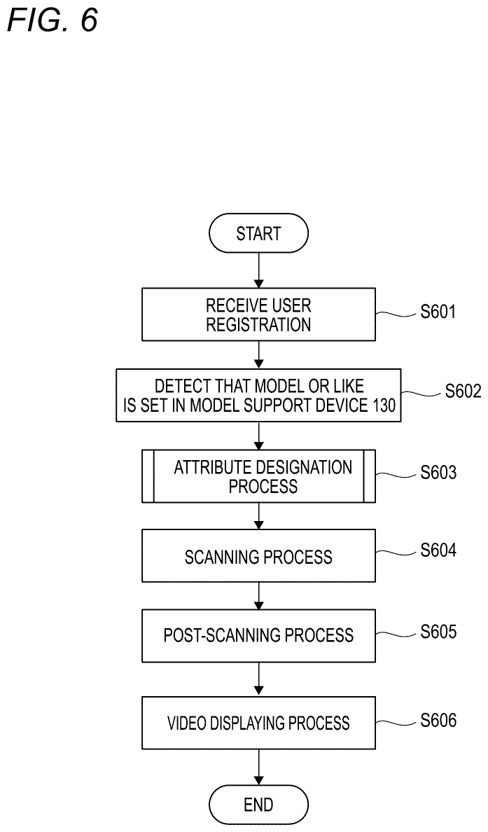

Next, an example of a process performed by the image processing system 10 according to the embodiment will be described with reference to FIG. 6. At least a part of the process corresponding to the flowchart is implemented by causing the CPU 101 of the information processing device 100 to execute a program stored in the ROM 103 or the storage device 104.

In S601, the CPU 101 first receives user registration. An input of a name or a contact address of a user is received. A user identifier for uniquely identifying an individual user is given to each user. The CPU 101 stores input user information in the storage device 104 in association with a time at which the input is received or the user identifier.

When the user registration is completed, the user sets the own model in the model support device 130. Based on a scan image by the scanner 110, the CPU 101 can determine whether the model 300 and the attachment 311 are set in the model support device 130. Alternatively, a switch that is turned on when the model 300 and the attachment 311 are set in the model support device 130 may be disposed so that the CPU 101 detects a signal from the switch to perform determination. Alternatively, a button that receives a manipulation when the setting of the model 300 and the attachment 311 is completed is displayed on the display device 140 and the CPU 101 can detect whether a manipulation is received for the button manipulation. In S602, the CPU 101 detects that the model 300 and the attachment 311 are set in the model support device 130 in accordance with any of the above-described methods. In response to the detection, the process proceeds to S603.

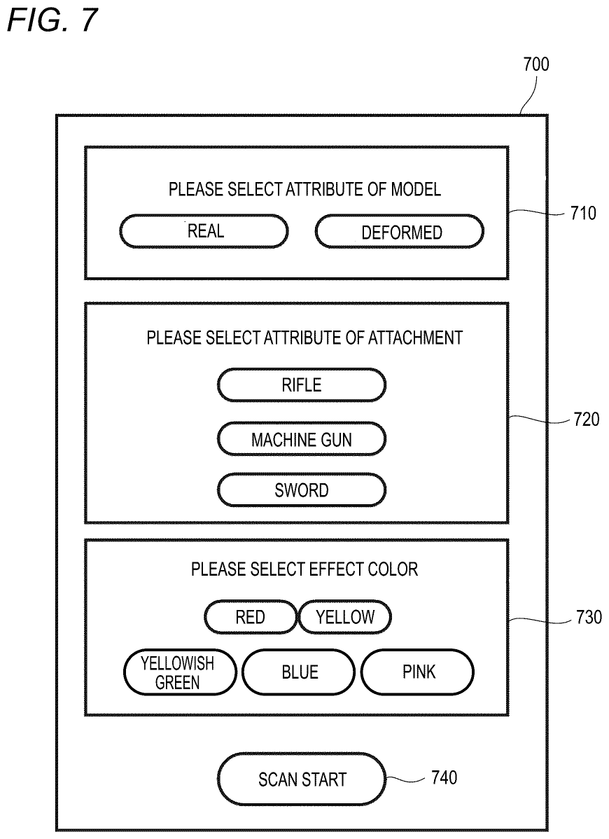

In S603, a process of receiving a designation of attributes of the model 300 and the attachment 311 is performed. Here, for example, a screen 700 illustrated in FIG. 7 is displayed, so that an attribute (type) of the model to be scanned from now, an attribute (type) of the attachment, and a color (effect color) used for an effect of an object and an attachment can be received.

The screen 700 of FIG. 7 can be displayed on, for example, the display device 140 and a manipulation input from the user can be received. For an attribute 710 of the model in the display of the screen 700, the user can select any of Real or Deformation. Since a feature of the outer appearance of the model different between Real and Deformation, the scanning method can also be selected in accordance with the selected attribute of the model. For example, in the case of Deformation, a range in which the scanner device 413 is movable may be set to be narrower than in the case of Real. In the attribute 710 of the model, scale values ( 1/144, 1/100, and 1/60) or the like of the model may be further designable. Accordingly, it is possible to further set a movable range of the scanner device 413 in accordance with a scale of the model.

Subsequently, for an attribute 720 of the attachment, the attachment is assumed to be a weapon here, and can be selected from any of a rifle, a machine gun, and a sword. The attribute of the weapon illustrated in FIG. 7 is merely exemplary and a more detailed attribute than the above can be designated. In FIG. 7, only the attack weapons are illustrated, but an attribute such as a defensive weapon or a shield may be designable. For an effect color 730, any of red, yellow, yellowish green, blue, and pink can be selected. The colors illustrated as the effect colors in FIG. 7 are merely exemplary and any color other than the colors can be designated.

A scan start button 740 is displayed in the screen 700, and thus the user can give an instruction to start the scanning when the designation of the attributes 710 to 730 is completed. When the instruction to start the scanning is given, the process proceeds to S604. At this time, the attribute information input via the screen of FIG. 7 is stored in association with the user information in the storage device 104.

In S604, as described with reference to FIGS. 5A to 5F, the scanner 110, the support arm 120, and the model support device 130 perform the scanning process (imaging process) in cooperation to generate a scan image. Specifically, the CPU 101 controls the support arm 120 to move the scanner 110 to any registered imaging position, and the scanner 110 can perform scanning while rotating the model support device 130 at the imaging position. After the model support device 130 is stopped at a predetermined rotational angle, the scanner 110 can be caused to perform the imaging operation at any imaging position and imaging angle. The captured scan image is transmitted to the information processing device 100 and the CPU 101 stores the scan image in association with the user identifier or the like in a table of the storage device 104.

Subsequently, in S605, the CPU 101 performs a post-scanning process on the scan image acquired through the scanning process, generates the 3-dimensional model data of each of the model 300 and the attachment 311, and generates video display application data (display data). In the post-scanning process, a region in which a range of unnecessary data is defined is generated in advance and surfaces included in a region in which it is not necessary to read data is deleted. Accordingly, surfaces other than the model 300 and the attachment 311 can be removed nearly. The unnecessary data range includes regions in which Action Base 411, the installation table 414, the frame 412, the support member 412A, the installation table 415, and the like are located.

When the generated application data is executed in a specific application in the information processing device 100, a video can be reproduced. When the generated application data is executed in the specific application in the head-mounted display 150A, a VR video can be reproduced. The generated 3-dimensional model data and display data are stored in the storage device 104 in association with the user information and the attribute information received in S603.

Subsequently, in S606, a video displaying process is performed. When the video displaying process is performed in the information processing device 100, the CPU 101 executes a specific application corresponding to the display data and displays the videos on the display device 140 via the display control unit 107. In S606, the CPU 101 may control the communication device 105 and transmit the display data to the HMD 150A and the CPU 151 of the HMD 150A may execute the received display data in a corresponding application and perform a process of displaying the VR video, so that the video displaying process is performed.

When the video is displayed, effects of the object or the attachment can be switched in accordance with the attribute information. for example, when the attachment 311 is a rifle attribute, single-shot firing is possible in the case of using the attachment 311. On the other hand, when the attachment 311 is a machine gun attribute, continuous firing is possible in the case of using the attachment 311. At that time, bullets are displayed with a color designated as an effect color.

In FIG. 6, the case in which the designation of the attribute information is received before start of the scanning process has been described and the embodiment is not limited thereto. A designation of the attribute information may be received after the scanning process of S604 or the post-scanning process of S605.

As described above, when the 3-dimensional model data generated from the image obtained by imaging the model by the scanner is disposed in the virtual space and the display data for displaying the video is generated, the attachments are simultaneously imaged along with the model, the 3-dimensional model data is generated, and the 3-dimensional model data of the attachments can be used in the virtual space along with the 3-dimensional model data of the model.

In this way, in the embodiment, a designation of the attribute information for the attachments can be received. Therefore, when the 3-dimensional model of the attachments is used in the virtual space, an effect can be implemented in accordance with the received attributes. Accordingly, since the user can reflect an own image in the effect related to the attachments, the user cannot feel discomfort. Further, since a designation for the type of model can be received as the attribute information, a scan image with higher accuracy can be acquired by controlling a scan range in accordance with the type of model.

In the above-described embodiment, weapons that are assumed as the attachments have been described, but types of attachments are not limited to the weapons. For example, when a model is a specific human character, the attachments may be cloth, accessories, and the like worn by the character. The model can also appear in an event, a concert, a sports game, an online conference, or the like carried out in a virtual space. Further, the technique of the embodiment can also be applied to a video technique capable of merging the real word and a virtual world, such as Cross Reality (XR) and allowing a person to perceive an object that is not present in the real space.

In this way, in the embodiment, the 3-dimensional model data can be generated from images obtained by imaging the outer appearance of a model and attachments and a video in which the 3-dimensional model is disposed in a virtual space can be viewed. Like an assembly plastic model, for example, a user can paint the model and the attachments and finish the model as a unique item. Since the individual feature can be reflected in representation of a character in a moving image or a virtual space, preference can be significantly improved.

### Conclusion of Embodiment

The above embodiment discloses the following information processing device and computer program.

(1) An information processing device including:
a scan controller configured to cause a scanner to scan an outer appearance of the object disposed on a table while controlling a position and an angle of the scanner and generate a scan image;
a data generator configured to generate 3-dimensional model data from the scan image;
a video generator configured to generate a video in which a 3-dimensional model based on the 3-dimensional model data is disposed in a virtual space; and
a receiver configured to receive an input of attribute information regarding the object that is a scanning target,
in which the video generator is configured to generate the video so that an effect is included for each object in accordance with the attribute information.

(2) The information processing device according to (1),
in which the object includes a first object and a second object,
in which the first object is disposed in a center of the table, and
in which the second object is disposed near an end of the table.

(3) The information processing device according to (2) in which the second object is an attachment of the first object.

(4) The information processing device according to (3), in which the first object is a humanoid model and the second object is an attachment component of the model.

(5) The information processing device according to any one of (2) to (4),
in which the first object is installed in first installation unit,
in which the second object is installed in second installation unit different from the first installation unit, and
in which at least a part of the first object is installed at a position higher than the second installation unit by the first installation unit.

(6) The information processing device according to (5), in which the at least a part of the first object includes a half of the first object.

(7) The information processing device according to (5) or (6), in which the data generator is configured to generate 3-dimensional model data of the first object and the second object while excluding a region where the first installation unit and the second installation unit are disposed from the scan image.

(8) The information processing device according to any one of (5) to (7), in which the second installation unit includes a frame surrounding the second object.

(9) The information processing device according to (8), in which the first object and the frame are disposed to be spaced or each have a size equal to or less than a predetermined size so that the first object is not shielded by the frame when an oblique surface of the first object on a side facing toward the frame is disposed is scanned.

(10) The information processing device according to (8) or (9), in which the second installation unit supports the second object inside the frame by a support member mounted on the frame.

(11) The information processing device according to (10), in which the data generator is configured to identify an object inside the frame in the scan image as the second object, and separately generate 3-dimensional model data of the first object and 3-dimensional model data of the second object from the scan image.

(12) The information processing device according to any one of (2) to (11), in which the first object and the second object are installed so that front faces thereof are oriented in an same direction.

(13) The information processing device according to any one of (2) to (12), in which the attribute information includes information of a type of the first object and a type of the second object.

(14) The information processing device according to (13), in which the attribute information further includes information regarding color used for an effect of at least one of the first object and the second object.

(15) The information processing device according to (13) or (14), in which the video generator is configured to include an effect video related to the second object based on the attribute information.

(16) The information processing device according to any one of (13) to (15), in which the scan controller is configured to control a position and an angle of the scanner in accordance with the attribute information of the type of the first object.

(17) The information processing device according to any one of (1) to (16), further including a motion controller configured to control motion of the table,
in which the motion controller is configured to rotate the table clockwise and counterclockwise.

(18) A non-transitory computer-readable storage medium that stores computer-executable program including instructions which, when executed by a computer, cause a computer to function as:
a scan controller configured to cause a scanner to scan an outer appearance of the object disposed on a table while controlling a position and an angle of the scanner and generate a scan image;
a data generator configured to generate 3-dimensional model data from the scan image;
a video generator configured to generate a video in which a 3-dimensional model based on the 3-dimensional model data is disposed in a virtual space; and
a receiver configured to receive an input of attribute information regarding the object that is a scanning target,
in which the video generator is configured to generate the video so that an effect is included for each object in accordance with the attribute information.

The present invention is not limited to the above embodiments and can be modified and changed in various forms within the scope of the gist of the present invention.

What is claimed is:

1. An information processing device comprising:
a scan controller configured to cause a scanner to scan an outer appearance of an object disposed on a table and generate a scan image;
a data generator configured to generate 3-dimensional model data from the scan image;
a video generator configured to generate a video in which a 3-dimensional model based on the 3-dimensional model data is disposed in a virtual space; and
a receiver configured to receive an input of attribute information regarding the object that is a scanning target,
wherein the video generator is configured to generate the video so that an effect is included for each object in accordance with the attribute information.

2. The information processing device according to claim 1,
wherein the object includes a first object and a second object,
wherein the first object is disposed in a center of the table, and
wherein the second object is disposed near an end of the table.

3. The information processing device according to claim 2, wherein the second object is an attachment of the first object.

4. The information processing device according to claim 3, wherein the first object is a humanoid model and the second object is an attachment component of the model.

5. The information processing device according to claim 2,
wherein the first object is installed in a first installation unit,
wherein the second object is installed in a second installation unit different from the first installation unit, and
wherein at least a part of the first object is arranged at a position higher than the second installation unit by the first installation unit.

6. The information processing device according to claim 5, wherein the at least a part of the first object includes a half of the first object.

7. The information processing device according to claim 5, wherein the data generator is configured to generate 3-dimensional model data of the first object and the second object while excluding a region where the first installation unit and the second installation unit are disposed from the scan image.

8. The information processing device according to claim 5, wherein the second installation unit includes a frame surrounding the second object.

9. The information processing device according to claim 8, wherein the first object and the frame are disposed to be spaced or each have a size equal to or less than a predetermined size so that the first object is not shielded by the frame when an oblique surface of the first object on a side facing toward the frame is scanned.

10. The information processing device according to claim 8, wherein the second installation unit supports the second object inside the frame by a support member mounted on the frame.

11. The information processing device according to claim 10, wherein the data generator is configured to identify an object inside the frame in the scan image as the second object, and separately generate 3-dimensional model data of the first object and 3-dimensional model data of the second object from the scan image.

12. The information processing device according to claim 2, wherein the first object and the second object are installed so that front faces thereof are oriented in an same direction.

13. The information processing device according to claim 2, wherein the attribute information includes information of a type of the first object and a type of the second object.

14. The information processing device according to claim 13, wherein the attribute information further includes information regarding color used for an effect of at least one of the first object and the second object.

15. The information processing device according to claim 13, wherein the video generator is configured to include an effect video related to the second object based on the attribute information.

16. The information processing device according to claim 13, wherein the scan controller is configured to control a position and an angle of the scanner in accordance with the attribute information of the type of the first object.

17. The information processing device according to claim 1, further comprising a motion controller configured to control motion of the table,
wherein the motion controller is configured to rotate the table clockwise and counterclockwise.

18. A non-transitory computer-readable storage medium that stores computer-executable program comprising instructions which, when executed by a computer, cause a computer to function as:
a scan controller configured to cause a scanner to scan an outer appearance of an object disposed on a table and generate a scan image;
a data generator configured to generate 3-dimensional model data from the scan image;
a video generator configured to generate a video in which a 3-dimensional model based on the 3-dimensional model data is disposed in a virtual space; and
a receiver configured to receive an input of attribute information regarding the object that is a scanning target,
wherein the video generator is configured to generate the video so that an effect is included for each object in accordance with the attribute information.
